(19) United States
(12) Patent Application Publication
(10) Pub. No.: US 2005/0194422 A1
(43) Pub. Date: Sep. 8, 2005

(54) Bump bonding apparatus and bump bonding method

(75) Inventors: Kuniyuki Takahashi, Musashimurayama-shi (JP); Fumihiko Kato, Fussa-shi (JP)

Correspondence Address: KODA & ANDROLIA, 2029 CENTURY PARK EAST, SUITE 1140, LOS ANGELES, CA, 90067, US

(73) Assignee: Kabushiki Kaisha Shinkawa

(21) Appl. No.: 11/071,842

(22) Filed: Mar. 3, 2005

(30) Foreign Application Priority Data
Mar. 3, 2004 (JP) 2004-059118

(51) Int. Cl. B23K 37/00

(52) U.S. Cl. 228/8; 228/180.5; 228/4.5

(57) ABSTRACT

A bump bonding apparatus and method in which a ball 6 is formed on the tip end of a wire 4 by an electric discharge between the wire 4 and a discharge electrode 3, and a bump 8 is formed by joining this ball 6 to the pad 2 of a semiconductor chip 1. In cases where the position of the capillary 5, when the capillary 5 is lowered following the next ball formation and the tip end portion of the wire (ball 6 or stripped bump) comes into contact with the electrode pad 2 drops below the lower limit of the permissible error range of the ball contacting level (first detected position H1) of the capillary 5 at a time when a normally formed ball 6, comes into contact with the electrode pad 2, a bump non-adhesion signal is outputted, and the bonding operation is stopped.

### BACKGROUND OF THE INVENTION

1. Technical Field

The present invention relates to a bump bonding apparatus and method that forms a ball on the tip end of a wire passing through a capillary and bonds this ball to a conductor to form a bump.

2. Description of the Related Art

Bump formation in wire bonding is generally accomplished by the steps (a) through (e) shown in FIG. 5. In FIG. 5, the reference numeral 1 is a semiconductor chip, 2 is an electrode pad that is formed on the surface of the semiconductor chip 1, and 3 is a discharge electrode.

First, in step (a), with a damper (not shown) closed, an electric discharge is made from the discharge electrode 3 onto the tail 4a of a wire 4 that passes through a capillary 5, thus forming a ball 6 on the tip end of the wire in step (b).

Next, in step (c), after the damper (not shown) is opened, the wire 4 is drawn back upward with an appropriate force by means of a back tension mechanism (not shown); and the capillary 5 is lowered so that the ball 6 comes into contact with the electrode pad 2.

Subsequently, in step (d), the ball 6 is pressed against the electrode pad 2, and the ball and the pad are joined by ultrasonic vibration; as a result, a bump 7 is formed on the pad.

The damper (not shown) and the capillary 5 are both raised in the next step (e), and the damper is closed at an intermediate point in this raising process, so that the wire 4 is cut from the bump 7. As a result, a final bump 8 is formed and bonded on the pad.

The above method is disclosed in, for instance, in Japanese Patent Application Laid-Open (Kokai) No. S54-2662, Japanese Patent Publication (Kokoku) No. H4-41519, and Japanese Patent Application Laid-Open (Kokai) No. H7-86286.

In the above bonding method, a bump non-adhesion would occur at the time of bump formation. This bump non-adhesion is a phenomenon in which when the joining strength of the bump 7 is insufficient, the formed bump 7 is stripped from the electrode pad 2 as shown in FIGS. 6(A) and 6(B). FIG. 6(A) shows a state in which the bump 7 is stripped when the capillary 5 is raised, and FIG. 6(B) shows a state in which the bump 7 is stripped when the wire 4 is cut.

Japanese Patent Application Laid-Open (Kokai) Nos. H11-191564 and 2000-306940 disclose a method for inspecting such a bump non-adhesion described above.

In the method of Japanese Patent Application Laid-Open (Kokai) No. H11-191564, in order to detect the state of non-adhesion, in which a bump (bump 7) is not joined to an electrode pad (electrode pad 2) of a semiconductor chip (semiconductor chip 1), the voltage required in order to initiate the discharge between the wire 4 and the discharge electrode 3 at the time of the formation of the next ball is measured, and non-adhesion is judged to have occurred in cases where this measured voltage exceeds a previously set threshold value. Thus, when a bump (bump 7) is not adhered to the electrode pad and the bump non-adhesion occurs, the discharge initiation voltage becomes greater than usual at the time of the next ball is formed, and bump non-adhesion is thus ascertained by measuring the voltage at the time of ball formation.

In the Japanese Patent Application Laid-Open (Kokai) No 2000-306940, after a bump (bump 7) is formed by joining a ball (ball 6) to an electrode pad (electrode pad 2) of a semiconductor chip (semiconductor chip 1), a voltage is applied to a wire (wire 4) during the time period extending up to the cutting of the wire (wire 4) from the bump (bump 7), and the presence or absence of non-adhesion of the bump (bump 7) is ascertained by detecting the variation in the voltage during the above-described time period according to the presence or absence of bump non-adhesion. More specifically, when non-adhesion of bump (bump 7) occurs during the time period extending up to the point where the a capillary (capillary 5) is raised and the damper is closed, no electrical pathway is established from the wire (wire 4) to the ground; as a result, an excessive voltage variation occurs; and non-adhesion is ascertained by measuring this voltage variation.

A bump bonding apparatus that forms the bumps 8 is typically constructed as shown in FIG. 7.

A bonding arm 20 which has a capillary 5 at one end is fastened to one end of a supporting frame 21. The supporting frame 21 is attached to a moving table 23 via a supporting shaft (not shown) or plate springs 22 assembled in a cruciform configuration, so that this supporting frame 21 is free to swing (or is swingable) in the vertical direction, and the moving table 23 is mounted on an XY table 24. The coil 26 of a linear motor 25 is fastened to the other end of the supporting frame 21, and the magnet 27 of the linear motor 25 is fastened to the moving table 23. A linear scale 28 is attached to the rear end of the supporting frame 21, and a position sensor 29 is attached to the moving table 23 so that it faces the linear scale 28.

This bump bonding apparatus further includes a heating block 31 that heats a device 30 that has the above-described semiconductor chip 1. The heating block 31 is raised and lowered by a raising-and-lowering mechanism 32.

Japanese Patent Application Laid-Open (Kokai) Nos. S58-184734 and H6-29343 and Japanese Patent Publication (Kokoku) No. H-6-80697 (that corresponds to Japanese Patent Application Laid-Open (Kokai) No. 61-163648) disclose the above described (bump) bonding apparatus.

In the above structure, the linear motor 25 makes the supporting frame 21 and bonding arm 20 swing about the supporting shaft or plate springs 22, so that the capillary 5 is raised and lowered. Furthermore, the moving table 23, supporting frame 21, bonding arm 20 and capillary 5 are moved in the X and Y directions (or to move horizontally) by the XY table 24. The bump 8 shown in FIG. 5 is formed on the device 30 by the formation of a ball on the tip end of the wire 4 by an electric torch (not shown), the raising and lowering movement of the capillary 5, the opening and closing movement of the wire cutting damper (not shown) at the time of wire cutting and the like.

Next, the control of the linear motor 25 and the operation of the respective blocks will be described.

The external input-output means 40 for the above bonding apparatus inputs and outputs various types of information required for operation with the computer 41. This input and output can be of a manual operation, or it can be accomplished by on-line communications with external devices. The computer 41 has a control circuit 42, a calculation circuit 43 and a height position counter 44; and the control circuit 42 controls the external input-output means 40, the calculation circuit 43 and a position control circuit 50.

When a height position command for the capillary 5 is inputted into the position control circuit 50 from the control circuit 42, the position control circuit 50 transmits a drive signal 50a representing the amount of movement of the capillary 5 to a motor driver 51. Then, the motor driver 51 produces electric power that is used to move the capillary 5 to a designated height position in accordance with the drive signal 50a. Since the electric power is a product of a voltage and a current, the actual control of the linear motor 25 can be accomplished by controlling the voltage or current, or both; and here, the system will be described in terms of the drive current 51a that flows to the linear motor 25. When the drive current 51a produced by the motor driver 51 is applied to the coil 26 of the linear motor 25, a driving force is generated; and the supporting frame 21, bonding arm 20 and capillary 5 are caused to swing about the plate springs 22 by this driving force.

The height position counter 44 produces the actual height position of the linear scale 28 by counting signals from an encoder 52 that converts the signals from the position sensor 29 into a signal format that is suitable to be inputted into the computer 41. A quantized coefficient (with one unit being equal to several micrometers) and the ratio of the amount of movement of the capillary 5 in the vertical direction to the amount of movement of the linear scale 28 in the vertical direction are provided to the computer 41 beforehand.

Accordingly, the actual height position of the capillary 5 is determined on the basis of this relationship by using the calculation circuit 43 to perform a mathematical operation on the value indicated by the height position counter 44.

In the above-described Japanese Patent Application Laid-Open (Kokai) No. H11-191564, the discharge voltage varies in accordance with the state of the wire 4 at the time that the next ball 6 is formed (i.e., a normally cut state of the wire 4 or a state of non-adhesion of the bump 7). As a result, bump non-adhesion is ascertained according to this variation in the discharge voltage, and the reliability of bump non-adhesion detection is higher than in the above-described Japanese Patent Application Laid-Open (Kokai) No 2000-306940. However, since there are numerous unstable elements such as the state of the tip end of the wire, the length of the tail 4a, the bending of the tail 4a, the conditions of alloy debris on the undersurface of the bump 7 stripped from the electrode pad 2 and the like, it is actually difficult to perform a normal evaluation.

In Japanese Patent Application Laid-Open (Kokai) No 2000-306940, since the current flows to a semiconductor chip (semiconductor chip 1), the method of this prior art may depend on the electrical characteristics of the semiconductor chip, and there may be semiconductor chips that may not be suitable. Furthermore, when the wire (wire 4) is cut, there is almost no difference in the voltage rise time between a state in which the wire (wire 4) is normally cut and a state in which the bump (bump 7) is not adhered or bonded; accordingly, when stripping occurs at the time that the wire is cut, then the detection is unable to execute.

### BRIEF SUMMARY OF THE INVENTION

The object of the present invention is to provide a bump bonding apparatus and method that has an extremely high reliability in terms of bump formation.

The above object is accomplished by a unique structure of the present invention for a bump bonding apparatus that includes:
a bonding arm which has a capillary in one end thereof and is swingably supported on a supporting frame,
a linear motor which drives the bonding arm in a swinging motion,
a position sensor which detects the position of the bonding arm in the vertical direction, and
a computer which has a height position counter that processes the signal from the position sensor and produces a signal indicative of the height position of the capillary, so that
a ball is formed at the tip end of a wire by performing an electric discharge between the wire and a discharge electrode, thus forming a bump by joining the ball to a conductor; and
in the present invention, the computer includes:
   a memory which stores a ball contacting level of the capillary and a bump formation level of the capillary, the ball contacting level being a height level of the capillary at a time when a normally formed ball comes into contact with the conductor, and the bump formation level being a height level of the capillary at a time when a normal bump is formed on the conductor, and
   a comparison circuit which outputs a bump non-adhesion signal in cases where the output value of the height position counter when the capillary is lowered following the next ball formation process and the tip end portion of the wire comes into contact with the conductor is outside a permissible error range of the ball contacting level that is stored in the memory.

The above object is further accomplished by a unique step of the present invention for a bump bonding method that forms a ball on the tip end of a wire by performing an electric discharge between the wire and a discharge electrode and forms a bump on a conductor by joining the ball to the conductor; and in the present invention,
the method includes the step of outputting a bump non-adhesion signal when the capillary position at a time when a capillary is lowered following the next ball formation process and the tip end portion of the wire comes into contact with the conductor falls below the permissible error range of a ball contacting level of the capillary, the ball contacting level being a height level of the capillary at a time when a normally formed ball on the wire comes into contact with the conductor, thus detecting bump non-adhesion.

In the present invention, in order to detect a non-adhesion state (or a bump non-adhesion state) in which the ball is not joined to the conductor and a bump is not formed on the conductor, a contacting level of a capillary, which is a height level of the capillary at the time that the capillary is lowered after the next ball formation so that the tip end portion of the wire (with a ball or with a stripped bump) comes into contact with the conductor, is used; and a judgment of whether or not a ball is joined to a conductor and a bump is formed on the conductor is made based upon the contacting level of the capillary. As a result, cases in which a ball is formed and cases in which a ball is not made and a stripped bump remains on the wire can be clearly distinguished as a result of the difference in the contacting level of the capillary. Thus, the reliability of bump non-adhesion detection is extremely high in the present invention.

### BRIEF DESCRIPTION OF THE DRAWINGS

FIG. 1 is an explanatory diagram showing the steps (a) through (e) in one embodiment of the bump non-adhesion detection method of the present invention;

FIG. 2 is an explanatory diagram of the bump bonding apparatus in one embodiment of the present invention;

FIG. 3 is an explanatory diagram of the steps (a) through (c) in which a bump was formed in a normal manner in the preceding bump formation step and thus a ball is formed on the wire in the next step in the bump bonding method of the present invention present;

FIG. 4 is an explanatory diagram showing the steps (a) through (c) in which a bump non-adhesion occurred in the preceding bump formation step and thus a ball is not formed on the wire in the in the next step in the bump bonding method of the present invention;

FIG. 5 is an explanatory diagram of bump formation steps (a) though (e) of prior art;

FIGS. 6(A) and 6(B) are explanatory diagrams showing the bump non-adhesion state; and

FIG. 7 is an explanatory diagram of a conventional bump bonding apparatus.

### DETAILED DESCRIPTION OF THE INVENTION

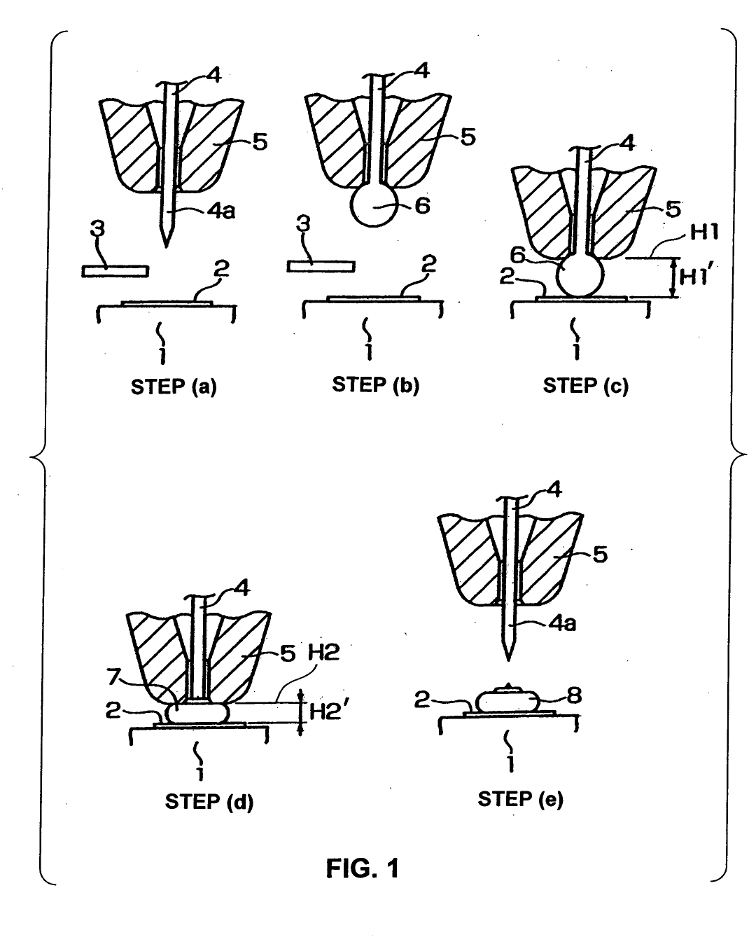

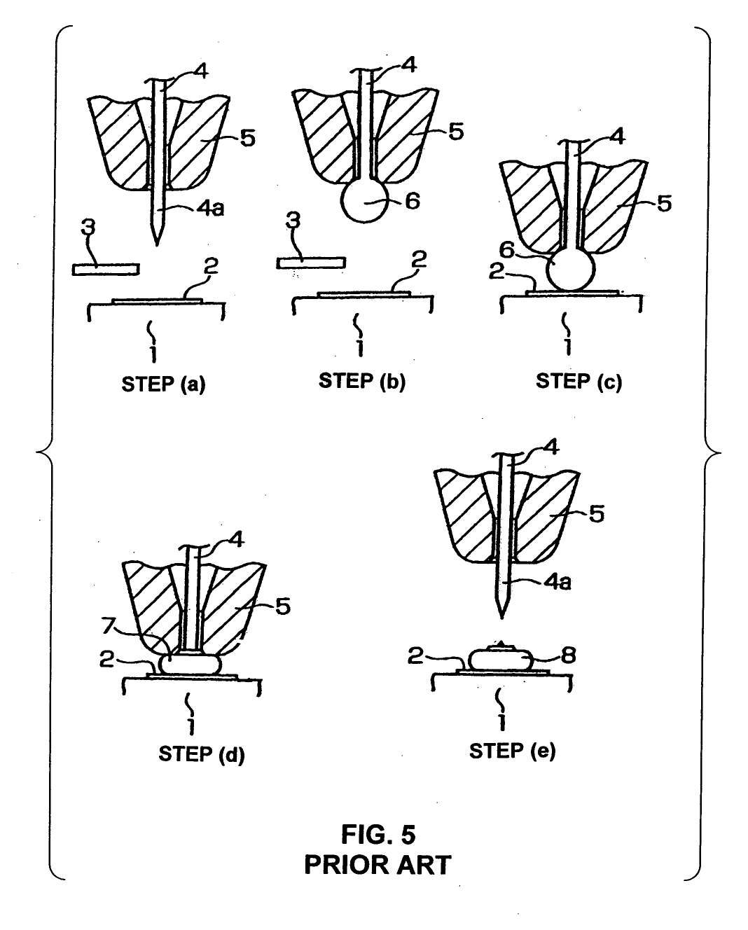

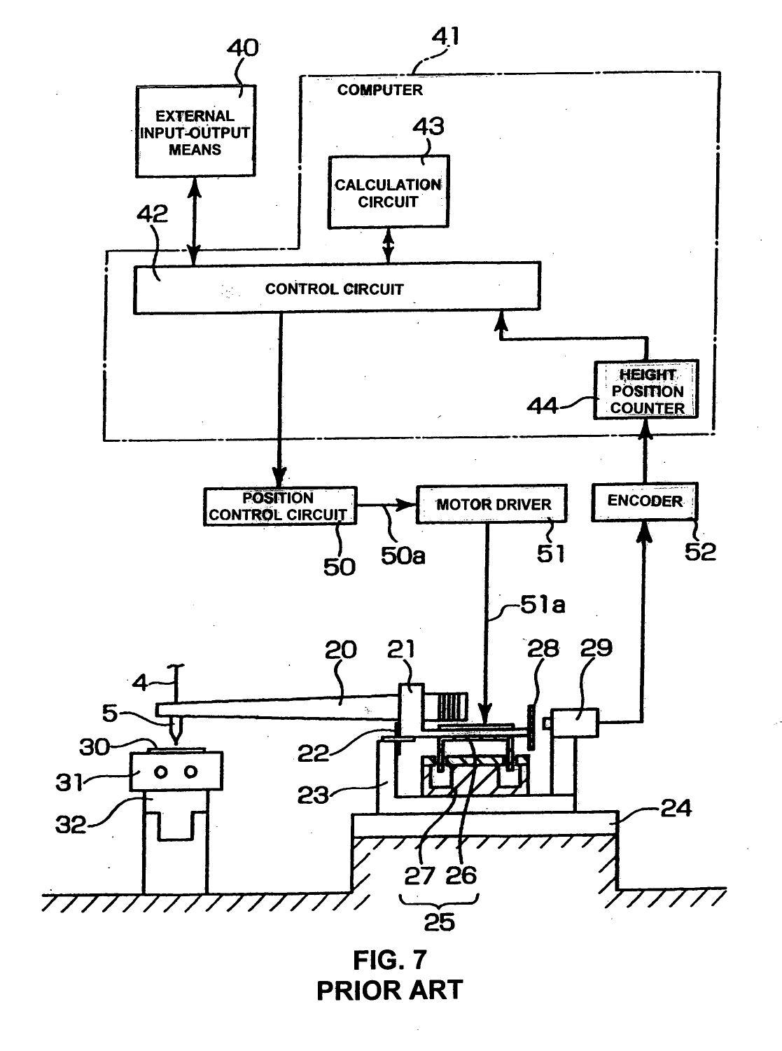

One embodiment of the present invention will be described with reference to FIGS. 1 through 4. In FIGS. 1 through 4, the same reference numerals are assigned to the members that are the same as those in FIGS. 5 through 7 or that correspond to the members in FIGS. 5 through 7, and a detailed description of such members is omitted.

FIG. 1 shows the steps (a) through (e) taken in the present invention and corresponds to FIG. 5.

First, the following work is performed prior to the bump formation. As shown in steps (a) and (b), a ball 6 is formed by performing an electric discharge on the tail 4a of a wire 4 from the discharge electrode 3.

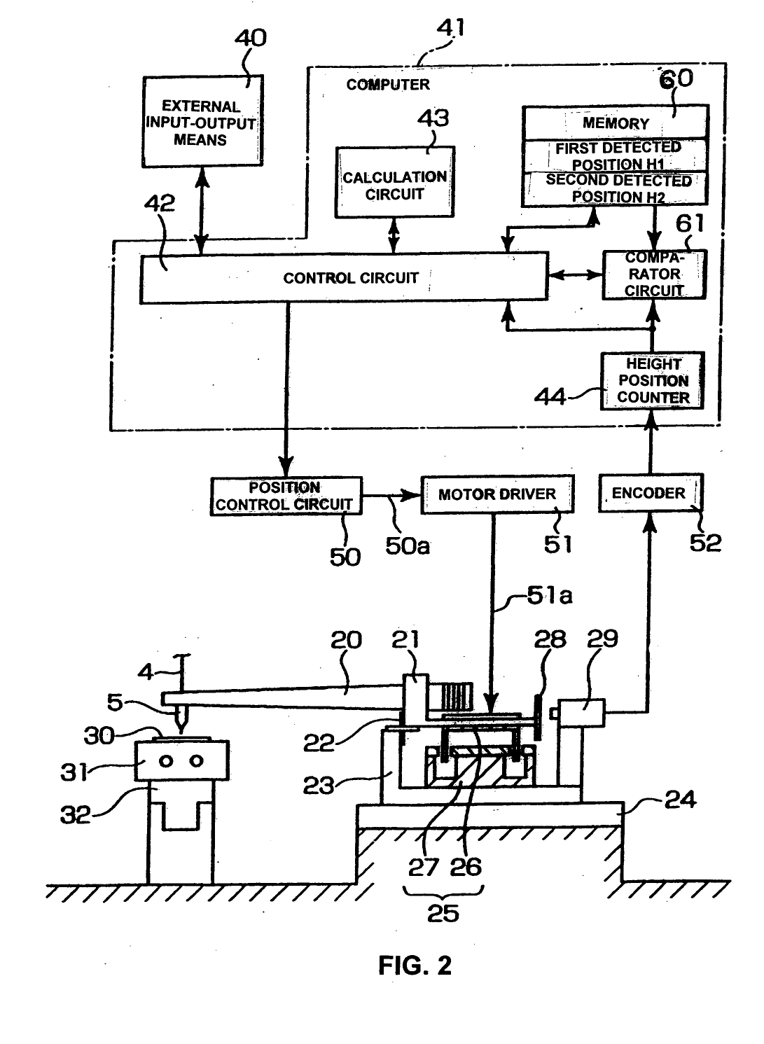

Next, in step (c), a first detected position H1, which is apart from the surface of the electrode pad with a distance of H1′ and is a contacting level of the ball at the lower end of the capillary 5 at the time when the capillary 5 is lowered and the ball 6 comes into contact with the electrode pad 2, is stored in the memory 60 of the computer 41 shown in FIG. 2. This first detected position H1 is stored in the memory as follows: namely, the height H1′ of the position of the capillary 5 in the state of step (c) is detected by the position sensor 29, the signal detected by the position sensor 29 is converted by the height position counter 44 via the encoder 52, and this converted value is stored in the memory 60 of the computer 41.

Next, in step (d), a second detected position H2, which is apart from the surface of the electrode pad with a distance of H2′ and is a formation level of bump at the lower end of the capillary 5 when the ball 6 is pressed against the electrode pad 2 and the ball and the pad are joined by ultrasonic vibration so that a bump 7 is formed, is stored in the memory 60 of the computer 41 in the same manner as the above-described first detected position H1.

The difference between the above-described positions H1 and H2 is the amount of crushing D of the ball 6 which can be shown by D=H1−H2. D=H1−H2 is calculated by the calculation circuit 43, and values that are smaller than this amount of crushing D are set in the permissible error range of the first detected position H1 stored in the memory 60. The computer 41 has a comparison circuit 61, and this comparison circuit 61 compares the value of the height position counter 44 and the value stored in the memory 60. In cases where the value of the height position counter 44 that is obtained when the capillary 5 is lowered so that the tip end portion of the wire 4 comes into contact with the electrode pad 2 following the ball formation process is outside the permissible error range of the first detected height position H1 stored in the memory 60, then the comparison circuit 61 outputs a bump non-adhesion signal.

Next, the operation of the system of the present invention will be described.

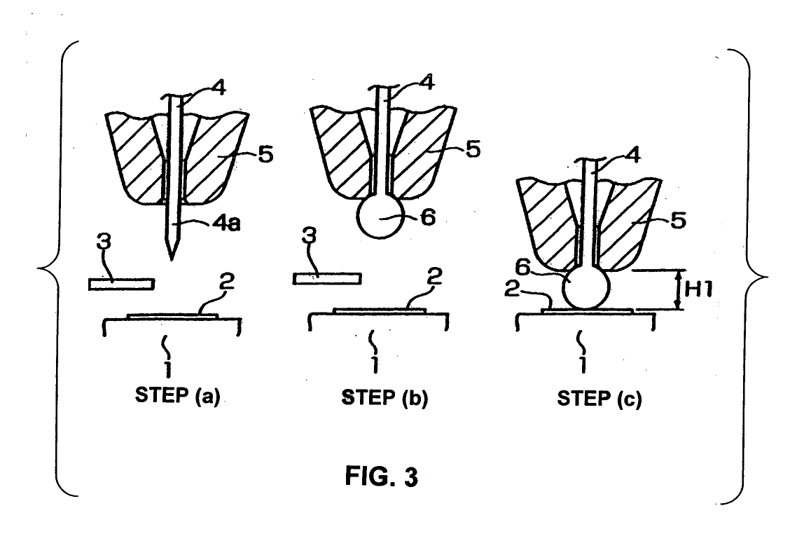

As shown in step (e) of FIG. 1, when the bump 8 is formed and adhered to the electrode pad, the wire 4 has a tail 4a of a specific length at the lower end of the capillary 5. Thus, when a normal bump 8 is formed and this bump is separated from the wire, a normal ball 6 can be formed at the lower end of the wire when an electric discharge is next performed from the discharge electrode 3 at the time of formation of the next ball in steps (a) and (b) in FIG. 3.

Then, the capillary 5 is lowered in step (c) of FIG. 3, and the ball 6 contacts the electrode pad 2, and the output value of the height position counter 44 in this case is compared with the first detected position H1 stored in the memory 60. If the ball 6 is formed in a normal manner, the output value of the height position counter 44 either coincides with the first detected position H1 stored in the memory 60 or is within the permissible error range of this position H1. Accordingly, there is no output from the comparison circuit 61, and the preceding bump formation is judged to be normal.

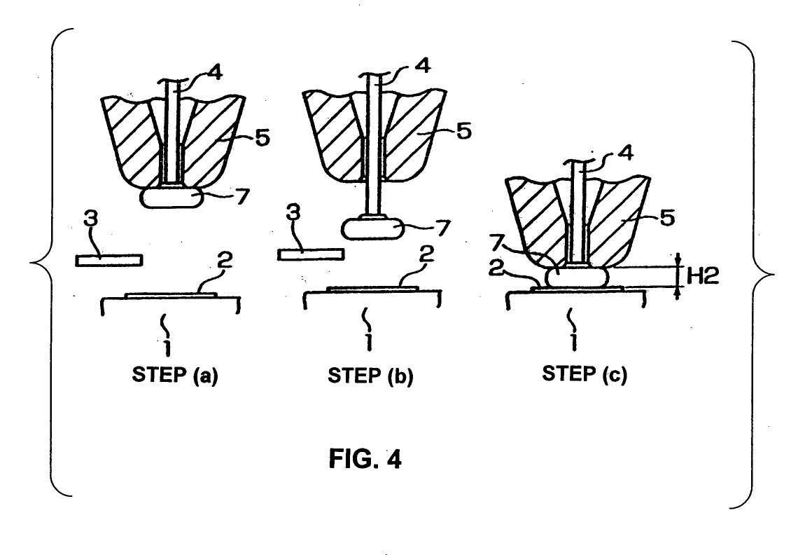

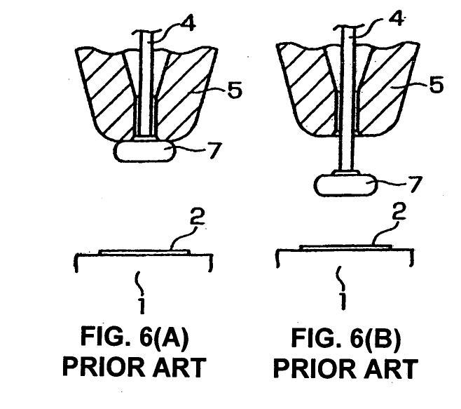

However, in cases where no bump 8 is formed on the electrode pad 2, and the bump 7 is stripped from the electrode pad 2 and remains on the wire (see FIGS. 6(A) and 6(B)), no ball 6 can be formed on the wire even if an electric discharge is performed from the discharge electrode 3 as seen in steps (a) and (b) in FIG. 4.

When the capillary 5 is lowered, the bump 7 on the wire comes into contact with the electrode pad 2 in step (c) in FIG. 4. The output value of the height position counter 44 in this case is compared with the first detected position H1 stored in the memory 60. In this case, the output value of the height position counter 44 equals to the value of the second detected position H2 stored in the memory 60 and is thus lower (smaller) than (the lower limit of) the permissible error range of the first detected position H1. Accordingly, a bump non-adhesion signal is outputted from the comparison circuit 61.

When the control circuit 42 receives this bump non-adhesion signal, the control circuit 42 judges that the preceding bump formation ended in failure (bump non-adhesion); and the control circuit 42 outputs an “abnormal” signal and stops the bump bonding apparatus.

As seen form the above, a non-adhesion state in which no ball 6 is joined to the electrode pad 2 to form a bump is judged according to the contacting level of the capillary when the capillary 5 is lowered following the next ball formation that allows the tip end portion (ball 6 or stripped bump 7) to come into contact with the electrode pad 2. In other words, cases in which a ball is formed at the end of a wire and cases in which the bump is a stripped bump 7 and no ball is formed on the wire end can be clearly distinguished as a result of the difference in the contacting levels. Accordingly, bump non-adhesion detection is reliably performed with an extremely high accuracy.

The above embodiment is described on a case in which bumps are formed on conductors which are electrode pads of semiconductor chips; however, it goes without saying that present invention is applicable to cases in which such bumps are formed on conductors such as leads or the like.

1. A bump bonding apparatus comprising:
a bonding arm which has a capillary in one end thereof and is swingably supported on a supporting frame,
a linear motor which drives said bonding arm in a swinging motion,
a position sensor which detects a position of said bonding arm in a vertical direction, and
a computer which has a height position counter that processes a signal from said position sensor and produces a signal indicative of a height position of said capillary, so that
a ball is formed at a tip end of a wire by performing an electric discharge between said wire and a discharge electrode, and a bump is formed by joining said ball to a conductor; wherein
said computer includes:
a memory which stores a ball contacting level of said capillary and a bump formation level of said capillary, said ball contacting level being a height level of said capillary at a time when an normally formed ball comes into contact with said conductor, and said bump formation level being a height level of said capillary at a time when a normal bump is formed on said conductor, and
a comparison circuit which outputs a bump non-adhesion signal in cases where an output value of said height position counter when said capillary is lowered following a next ball formation step and a tip end portion of said wire comes into contact with said conductor is outside a permissible error range of said ball contacting level that is stored in said memory.

2. A bump bonding method that forms a ball on a tip end of a wire by performing an electric discharge between said wire and a discharge electrode and then forms a bump by joining said ball to a conductor, wherein said method includes the step of:
outputting a bump non-adhesion signal when a capillary position at a time when a capillary is lowered following a next ball formation step and a tip end portion of said wire comes into contact with said conductor falls below a permissible error range of a ball contacting level of said capillary, said ball contacting level being a height level of said capillary at a time when a normally formed ball on said wire comes into contact with said conductor.
